(19) United States
(12) Patent Application Publication
(10) Pub. No.: US 2014/0294373 A1
(43) Pub. Date: Oct. 2, 2014

(54) CAMERA ROTATING STRUCTURE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: HAN CHEN, Shenzhen (CN); PEI-HUA ZHANG, Shenzhen (CN); WEI-KUANG LIANG, New Taipei (TW); QUAN-GUANG DU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/105,620

(22) Filed: Dec. 13, 2013

(30) Foreign Application Priority Data
Mar. 29, 2013 (CN) 2013101073679

(51) Int. Cl. G03B 17/56

(52) U.S. Cl. CPC G03B 17/561
USPC 396/428

(57) ABSTRACT

A camera rotating structure includes a bottom frame, a rotating device, a camera device, and a top frame. The rotating device comprises an operating tab, the rotating device are pivotally mounted to an inner side of the bottom frame. The camera device comprises a base board and a camera. The base board is secured to the rotating device. The top frame defines a through opening to expose the camera and a mounting opening. The top frame is mounted to the bottom frame to enable the rotating device and the camera device to be mounted between the top frame and the bottom frame. The operating tab extends through the mounting opening exposing out of the top frame. The operating tab is operated in the mounting opening to move to drive the rotating device to rotate, thereby driving the camera to rotate to adjust an angle of the camera.

### BACKGROUND

1. Technical Field

The present disclosure generally relates to a camera rotating structure of a notebook computer.

2. Description of Related Art

The notebook computer is widely used with a little weight. The notebook usually includes a camera. However, the camera cannot be rotated independently, which is inconvenient for people who adjust the angle of the camera.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled view of one embodiment of a camera rotating structure.

FIG. 2 is an exploded, isometric, and cutaway view of one embodiment of a camera rotating structure.

FIG. 3 is similar to FIG. 2, but viewed from another aspect.

FIG. 4 is a cross-sectional, cutaway view of FIG. 1.

FIG. 5 is another cross-sectional, cutaway view of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

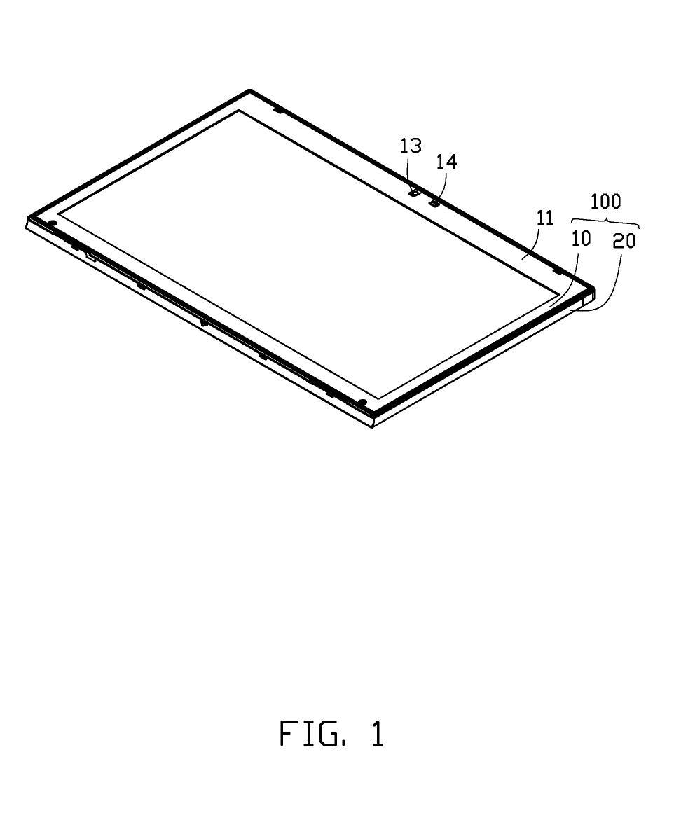

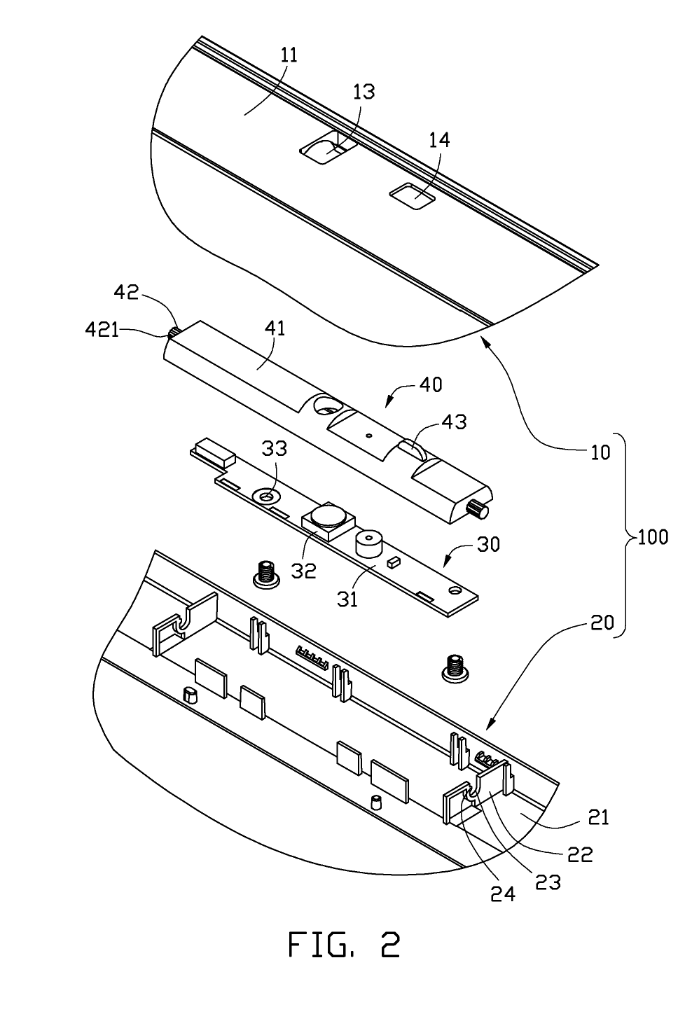

FIGS. 1 and 2 show a camera rotating structure according to one embodiment.

The camera rotating structure includes an enclosure 100 for mounting a display, a camera device 30, and a rotating device 40. The enclosure 100 includes a top frame 10 and a bottom frame 20.

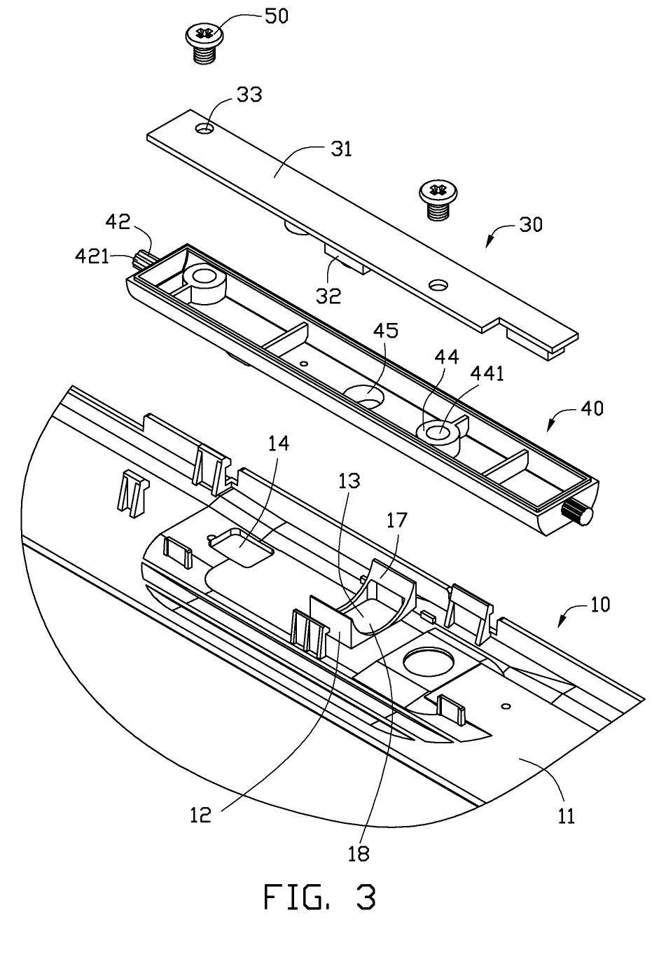

FIGS. 2 and 3 show that the top frame 10 includes a top panel 11. The top panel 11 defines a through opening 13 and a mounting opening 14. The top frame 10 further includes a mounting portion 12 extending from an inner side of the top panel 11. The mounting portion 12 defines a recess surface 17. The mounting portion 12 defines a mounting space 18 surrounded by the recess surface 17. The recess surface 17 is arc-shaped. The mounting space 18 communicates with the through opening 13.

The bottom frame 20 includes a bottom panel 21 and two pivoting portions 22 extending from inward from the bottom panel 21. Each pivoting portion 22 defines a cutout 23. Each pivoting portion 22 includes a protrusion 24 extending from the edge of the cutout 23. The cutout 23 is U-shaped.

The camera device 30 includes a base board 31 and a camera 32 mounted to the base board 31. The base board 31 defines two securing holes 33.

The rotating device 40 includes a rotating body 41, two rotating posts 42 extending from opposite ends of the rotating body 41, an operating tab 43 extending from the rotating body 41, and two mounting posts 44. The rotating body 41 defines a through hole 45 corresponding to the camera 32. The rotating post defines walls 421. Each mounting post 44 defines a mounting hole 441 corresponding to the securing hole 33.

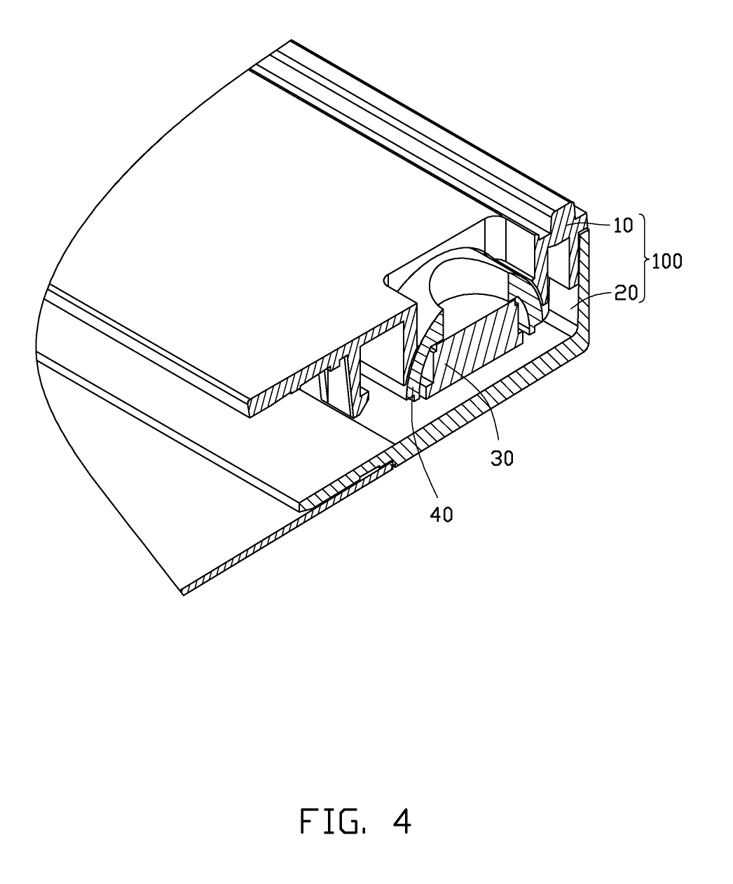

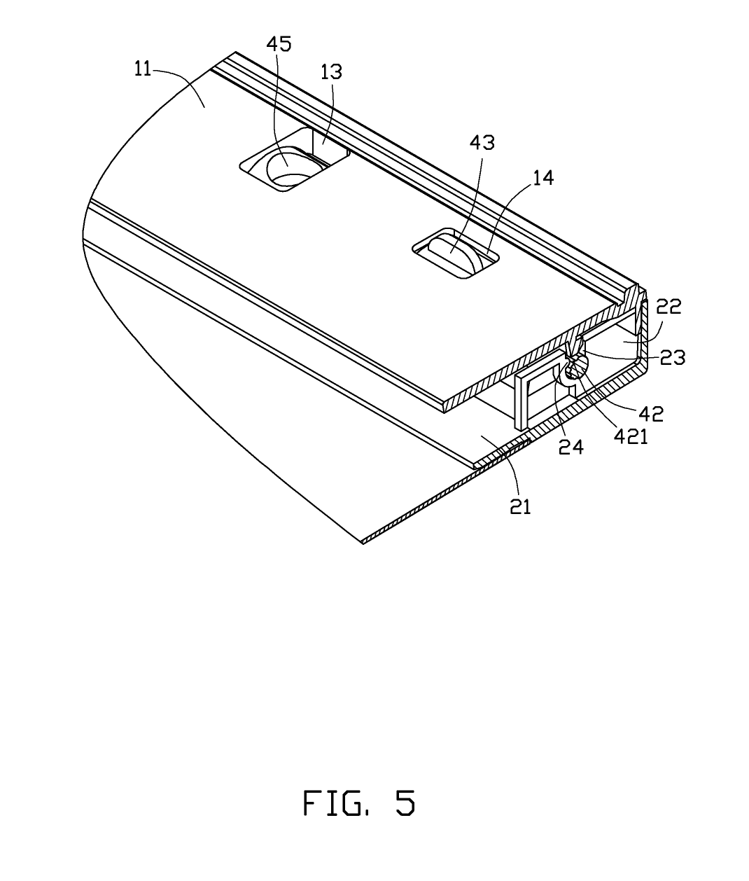

FIGS. 3 to 5 show that in assembly, the camera device 30 is placed on the rotating device 40. The two securing holes 33 of the camera device 30 are aligned with the mounting holes 441 of the rotating body 41. At this time, the camera 32 is aligned with the through hole 45. Two fasteners 50 are screwed into the securing holes 33 and the corresponding mounting holes 441 to secure the camera device 30 to the rotating device 40. The rotating device 40 with the camera device 30 is placed on the bottom frame 20 to enable the rotating posts 42 to be received in the cutouts 23 to enable the rotating device 40 to be pivotally mounted to the bottom frame 20. At this time, the rotating body 41 and the camera device 30 are located between the two pivoting portions 22. The top frame 10 is placed on the bottom frame 20 to enable the operating tab 43 of the rotating device 40 to pass through the mounting opening 14 of the top frame 10. The through opening 13 of the top frame 10 is aligned with the through hole 45 of the rotating device 40. The top frame 10 is secured to the bottom frame 20 via a plurality of fasteners (not shown), thereby the rotating device 40 and the camera device 30 are mounted between the top frame 10 and the bottom frame 20.

When the camera device 30 is needed to be adjusted, the operating tab 43 is operated to drive the rotating device 40 to rotate, thereby driving the camera 32 of the camera device 30 to rotate. The protrusion 24 is used for resisting the walls 421 of the rotating posts 42 to prevent the rotating device from moving after the rotating device 40 is operated to rotate to an angle.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

1. A camera rotating structure comprising:
a bottom frame, the bottom frame comprises a bottom panel and two pivoting portions extending inward from the bottom panel, each of the two pivoting portions defining a cutout, and having a protrusion extending from an edge of the cutout;
a rotating device, the rotating device comprises a rotating body, two rotating posts extending from opposite ends of the rotating body, a plurality of ribs extending from an outer surface of the each of the two rotating posts, and an operating tab extending from the rotating body; and the two rotating posts are pivotally mounted to the two pivoting portions;
a camera device, the camera device comprises a base board and a camera mounted to the base board, wherein the base board is secured to the rotating body; and
a top frame, the top frame defines a through opening to expose the camera and a mounting opening receiving the operating tab, and the top frame is mounted to the bottom frame to enable the rotating device and the camera device to be mounted between the top frame and the bottom frame;
wherein the two rotating posts are rotatable to engage the protrusion in a gap between two adjacent ribs of the plurality of ribs, and the operating tab is operated to drive the rotating device to rotate, thereby driving the camera to rotate.

2-3. (canceled)

4. The camera rotating structure of claim 1, wherein the cutout is U-shaped.

5. The camera rotating structure of claim 1, wherein the rotating body defines a through hole corresponding to the camera, and the through hole is aligned with the through opening.

6. The camera rotating structure of claim 5, wherein the top frame comprises a top panel and a mounting portion extending inward from the top panel, and the mounting portion defines a mounting space for receiving the rotating body.

7. The camera rotating structure of claim 6, wherein the mounting portion defines a recess surface surrounding the mounting space, and the recess surface is arc-shaped.

8. The camera rotating structure of claim 6, wherein the mounting space communicates with the through opening.

9. A camera rotating structure comprising:
a bottom frame comprising two pivoting portions, each pivoting portion defining a cutout, and a protrusion extending from an edge of the cutout;
a rotating device, the rotating device comprises an operating tab and two rotating posts, the rotating device is pivotally mounted to an inner side of the bottom frame;
a plurality of ribs extending from an outer surface of the each of the two rotating posts;
a camera device, the camera device comprises a base board and a camera mounted to the base board wherein the base board is secured to the rotating device; and
a top frame, the top frame defines a through opening to expose the camera and a mounting opening, and the top frame is mounted to the bottom frame to enable the rotating device and the camera device to be mounted between the top frame and the bottom frame;
wherein the two rotating posts are rotatable to engage the protrusion in a gap between two adjacent ribs of the plurality of ribs, the operating tab extends through the mounting opening to be exposed out of the top frame, and the operating tab is operated in the mounting opening to move to drive the rotating device to rotate, thereby driving the camera to rotate to adjust an angle of the camera.

10. The camera rotating structure of claim 9, wherein the bottom frame comprises a bottom panel; the two pivoting portions extending extend inward from the bottom panel;
the rotating device comprises a rotating body; the two rotating posts extend from opposite ends of the rotating body;
the operating tab extends from the rotating body; and
the two rotating posts are pivotally mounted to the two pivoting portions.

11. The camera rotating structure of claim 10, wherein
the two rotating posts are pivotally mounted in the two cutouts.

12. (canceled)

13. The camera rotating structure of claim 10, wherein the cutout is U-shaped.

14. The camera rotating structure of claim 10, wherein the rotating body defines a through hole corresponding to the camera, and the through hole is aligned with the through opening.

15. The camera rotating structure of claim 14, wherein the top frame comprises a top panel and a mounting portion extending inward from the top panel, and the mounting portion defines a mounting space for receiving the rotating body.

16. The camera rotating structure of claim 15, wherein the mounting portion defines a recess surface surrounding the mounting space, and the recess surface is arc-shaped.

17. The camera rotating structure of claim 15, wherein the mounting space communicates with the through opening.
